(19) United States
(12) Patent Application Publication
(10) Pub. No.: US 2014/0016347 A1
(43) Pub. Date: Jan. 16, 2014

(54) SURFACE ILLUMINATION DEVICE

(71) Applicants: Mitsuru Okuda, Shiga (JP); Yoshimasa Osumi, Kyoto (JP); Kazuyuki Okada, Shiga (JP)

(72) Inventors: Mitsuru Okuda, Shiga (JP); Yoshimasa Osumi, Kyoto (JP); Kazuyuki Okada, Shiga (JP)

(73) Assignee: OMRON CORPORATION, Kyoto-shi, Kyoto (JP)

(21) Appl. No.: 14/002,029

(22) PCT Filed: Mar. 7, 2012
(86) PCT No.: PCT/JP2012/055841

§ 371 Date: Oct. 2, 2013

(30) Foreign Application Priority Data
Mar. 15, 2011 (JP) 2011-057300

(51) Int. Cl. F21V 8/00

(52) U.S. Cl. CPC G02B 6/005
USPC 362/606

(57) ABSTRACT

A surface illumination device has a light source, and a light guide plate having a light-emitting surface. The light guide plate guides light from the light source such that the light is emitted from a display region of the light-emitting surface. A plurality of deflection patterns having deflection inclined surfaces are formed in the display region in at least one of the light-emitting surface of the light guide plate and an opposite surface to the light-emitting surface. A light control structure that reduces light is provided on at least part of at least one of the light-emitting surface of the light guide plate and a surface except the opposite surface to the light-emitting surface, the light being reflected toward the display region by the surface.

### BACKGROUND

1. Technical Field

The present invention relates to a surface illumination device. Specifically, the present invention relates to a surface illumination device, which is used in display while incorporated in mobile devices such as a smartphone and a tablet computer.

2. Related Art

In the smartphone, the tablet computer, an electronic book reader, and the like, an icon is lighted in a position of a switch, and the position and a type of the switch is expressed by the icon. For example, in a smartphone 11 in FIG. 1(A), an icon 13 is displayed below a liquid crystal display screen 12. Although the icon 13 is expressed by a character “A” in FIGS. 1(A), actually design marks such as a house and a magnifying glass are frequently used. When the icon 13 is pressed by a finger, a switch 14 provided beneath the icon 13 is turned on to switch a function of the smartphone 11.

FIG. 1(B) illustrates a surface illumination device 15 for the display, which is incorporated in a lower portion of the smartphone 11 in FIG. 1(A). FIG. 2(A) illustrates a schematic section of the surface illumination device 15. The surface illumination device 15 includes a light guide plate 16 and a light source 17. The light guide plate 16 is molded using a transparent material, such as a polycarbonate (PC) resin and a polymethylmethacrylate (PMMA) resin, which has a high refractive index. The light source 17 is a minute light source (a point light source) in which an LED is used, and the light source 17 is disposed while a light exit window is opposed to one (light incident end face 16a) of end faces of the light guide plate 16. Many minute prism deflection patterns 18 are formed in a lower surface (sometimes an upper surface) of the light guide plate 16, and an icon-shaped display unit 19 is constructed by a set of deflection patterns 18 as illustrated in FIG. 2(B). The deflection patterns 18 are arrayed into an arc shape about a point near the light source 17, and extend in directions along the arc about the point. A thin, flexible light guide sheet is used as the light guide plate 16 in the case that the switch 14 is disposed beneath the display unit 19.

When the light source 17 emits light in the surface illumination device 15, the light incident to the light guide plate 16 from the light incident end face 16a is guided in the light guide plate 16 while totally reflected by the upper surface, the lower surface, and both side surfaces of the light guide plate 16. When the light guided in the light guide plate 16 reaches the display unit 19 as illustrated in FIG. 2(A), the light is totally reflected by a deflection reflecting surface 18a of the deflection pattern 18. In the light totally reflected upward by the deflection reflecting surface 18a, the light incident to the upper surface (a light-emitting surface 16c) of the light guide plate 16 at an angle smaller than a total reflection critical angle is transmitted through the light incident end face 16a to emit upward (the light is transmitted while refracted by the deflection pattern 18 in the case that the deflection pattern 18 is provided in the light-emitting surface 16c). As a result, the light emits into the icon shape to light the icon 13 of the smartphone 11.

However, in the smartphone 11 in which the surface illumination device 15 is used, when a user vertically inclines the smartphone 11 while holding the smartphone 11 in the hand, unfortunately luminance of the icon 13 repeats being brightened and darkened, and the icon 13 is seen while flickering. The reason the phenomenon is generated will be described with reference to FIGS. 3 and 4. FIG. 3(B) illustrates a directional pattern of the light emitting from the light-emitting surface 16c of the light guide plate 16 when the directional pattern is viewed from a direction (a Z-direction) perpendicular to the light-emitting surface 16c, an X-direction indicates a length direction (a crosswise direction of the smartphone 11) of the light guide plate 16, and a Y-direction indicates a width direction (a longitudinal direction of the smartphone 11) of the light guide plate 16.

In the case that the light emitted from the small light source 17 is totally reflected by the deflection pattern 18 to emit from the light-emitting surface 16c, because the light headed from the light source 17 to certain deflection pattern 18 is the light having a narrow range when viewed from the direction perpendicular to the light-emitting surface 16c, the light emitting from the light-emitting surface 16c also has the narrow directivity. That is, light La that goes straight to reach the display unit 19 or the deflection pattern 18 as illustrated in FIG. 3(A) has a directional pattern Ca that is lengthened in the X-direction as illustrated in Fig. 3(B). Therefore, although the light having the directional pattern Ca can be recognized with high luminance from the front direction of the smartphone 11, the light becomes dark when the smartphone 11 is vertically inclined.

In the light incident to the display unit 19, part of the light is incident to the deflection pattern 18 after totally reflected by a side surface 16b of the light guide plate 16 like light Lb in FIG. 3(A). As indicated by a broken line in FIG. 2(A), the light Lb is obliquely incident to the deflection pattern 18 and totally reflected toward the oblique direction by the deflection pattern 18. Therefore, the light Lb emitting from the light-emitting surface 16c has a narrow directional pattern Cb that is inclined as illustrated in FIG. 3(B).

As described above, because the light Lb having the directional pattern Cb is added to the light La having the directional pattern Ca, a bright region B and a dark region D are alternately generated when viewed from the X-direction (a substantially vertical direction when the user holds the smartphone 11 in the hand) as illustrated in FIG. 4. Therefore, when the user vertically inclines the smartphone 11, a sight line alternately passes through the bright region B and the dark region D, and the icon 13 is seen while flickering.

Patent Document 1: Japanese Unexamined Patent Publication No. 2001-243822

### SUMMARY

One or more embodiments of the present invention provides a surface illumination device that can remove extra stray light degrading visual quality of the display such as the icon. Particularly one or more embodiments of the present invention provides a surface illumination device that can reduce a phenomenon in which the display is seen while flickering when the seeing position is changed in a plane orthogonal to the direction of the light toward the display unit from the light source.

In accordance with one or more embodiments of the present invention, a surface illumination device includes: a light source; and a light guide plate that causes light guided from the light source to emit from a display region of a light-emitting surface, wherein a plurality of deflection patterns having deflection inclined surfaces are formed in the display region in at least one of the light-emitting surface of the light guide plate and an opposite surface to the light-emitting surface, and light control means for reducing light is provided at least part of at least one of the light-emitting surface of the light guide plate and a surface except the opposite surface to the light-emitting surface, the light being reflected toward the display region by the surface.

In a surface illumination device according to one or more embodiments of the present invention, the light control means for reducing the light is provided at least part of at least one of the light-emitting surface of the light guide plate and the surface except the opposite surface to the light-emitting surface, the light being reflected toward the display region by the surface. Therefore, the light can be prevented from reaching the display region from an undesirable direction to shine the display region. Accordingly, the extra stray light is reduced, the flickering of the display region is hardly generated even if the seeing direction is changed or the instrument into which the surface illumination device is incorporated is inclined when the display region emits the light.

In a surface illumination device according to one or more embodiments of the present invention, the light control means is a notch unit in which an angle is fixed such that the light incident to the light control means is transmitted toward an outside of the light guide plate. The light, which is reflected by certain surface of the light guide plate to reach the display region from the undesirable direction, can be transmitted to the outside from the notch unit. Accordingly, the light reaching the display unit from the undesirable direction can be reduced.

In a surface illumination device according to one or more embodiments of the present invention, the light control means is a light-absorbing layer that absorbs the light incident to the light control means. The light, which is reflected by certain surface of the light guide plate to reach the display region from the undesirable direction, can be absorbed by the light-absorbing layer that is of the light control means. Accordingly, the light reaching the display unit from the undesirable direction can be reduced.

In a surface illumination device according to one or more embodiments of the present invention, the light control means is a light scattering surface that scatters the light incident to the light control means. The light, which is reflected by certain surface of the light guide plate to reach the display region from the undesirable direction, can be scattered by the light scattering surface that is of the light control means. Accordingly, the light reaching the display unit from the undesirable direction can be reduced.

In accordance with one or more embodiments of the present invention, a mobile phone that has transmission and reception functions, includes the surface illumination device in order to optically display certain shape. In one or more embodiments of the present invention, the surface illumination device according to one or more embodiments of the present invention is used in mobile phones such as the smartphone. Accordingly, the display such as the optically-displayed icon can be prevented from flickering.

In accordance with one or more embodiments of the present invention, an information terminal that has an information processing function includes the surface illumination device according to one or more embodiments the present invention in order to optically display certain shape. In one or more embodiments of the present invention, the surface illumination device according to one or more embodiments of the present invention is used in information terminals such as a mobile computer, the tablet computer, an electronic diary, and an electronic dictionary. Accordingly, the display such as the optically-displayed icon can be prevented from flickering.

The present invention includes variations that can be made by the combination of components.

### BRIEF DESCRIPTION OF THE DRAWINGS

FIG. 1(A) is a plan view of a smartphone. FIG. 1(B) is a plan view of a surface illumination device incorporated in the smartphone in FIG. 1(A).

FIG. 2(A) is a schematic sectional view of the surface illumination device in FIG. 1(B) together with one enlarged deflection pattern. FIG. 2(B) is a plan view of a display unit (deflection pattern region) provided in a light guide plate.

FIG. 3(A) is a view illustrating light incident to the display unit in the surface illumination device in FIG. 1(B). FIG. 3(B) is a view illustrating a directional pattern of the light emitting from a light-emitting surface of a light guide plate when viewed from a direction perpendicular to the light-emitting surface.

FIG. 4 is a view illustrating a problematic point of the surface illumination device in FIG. 1(B).

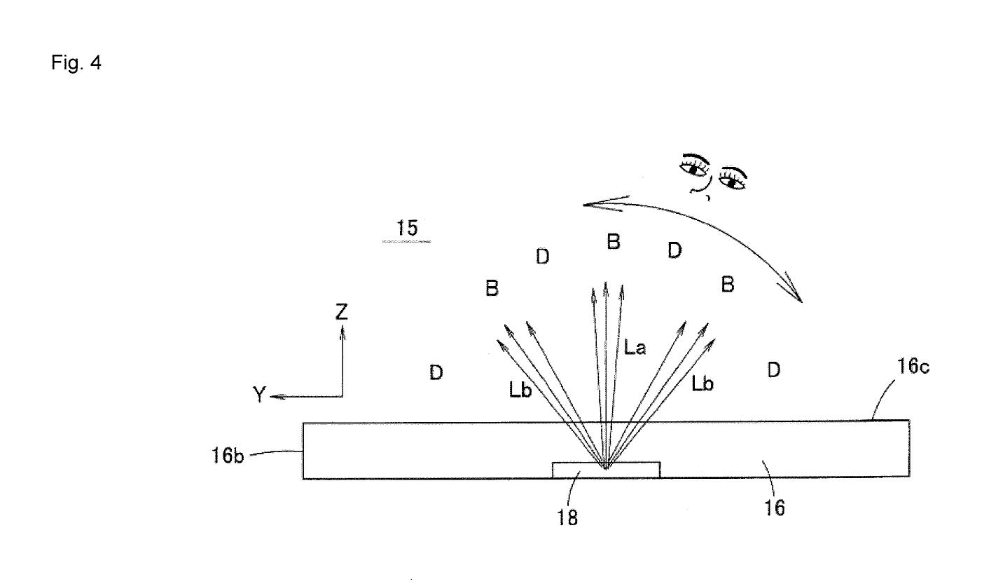

FIG. 5 is a schematic plan view of a surface illumination device according to a first embodiment of the present invention.

FIG. 6 is an explanatory view of action of the surface illumination device of the first embodiment.

FIGS. 7(A) and 7(B) are enlarged perspective views of a deflection pattern.

FIG. 8 is a schematic plan view of a surface illumination device according to a second embodiment of the present invention.

FIG. 9 is a schematic plan view of a surface illumination device according to a third embodiment of the present invention.

### DESCRIPTION OF SYMBOLS

11 smartphone
12 liquid crystal display screen
13 icon
16 light guide plate
16a light incident end face
16b side surface
16c light-emitting surface
17 light source
18 deflection pattern
19 display unit
21, 31, 41 surface illumination device
22 notch
32 light-absorbing layer
42 light scattering surface

### DETAILED DESCRIPTION

Hereinafter, embodiments of the present invention will be described in detail with reference to the accompanying drawings. However, the present invention is not limited to the following embodiments, but various design changes can be made without departing from the scope of the present invention. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

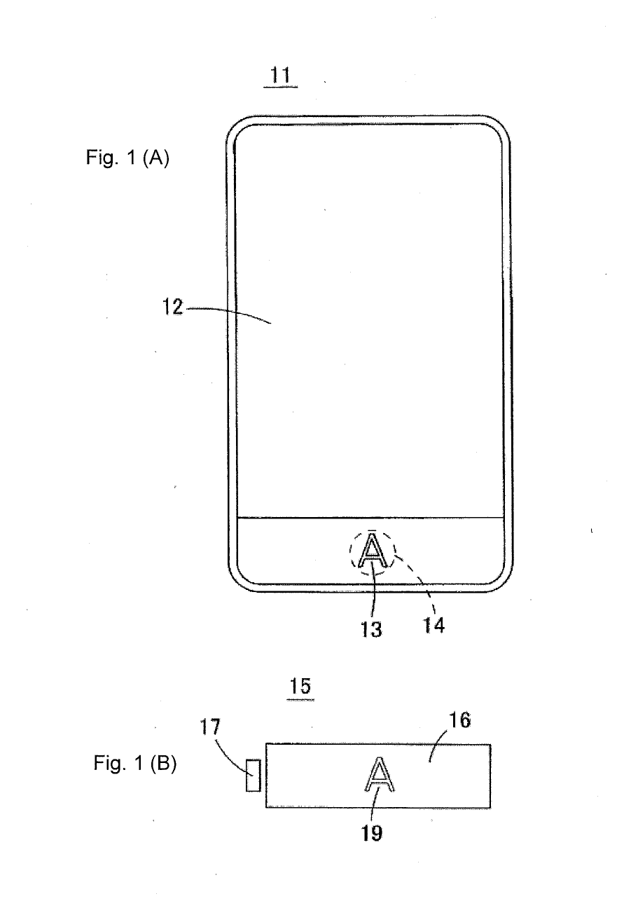

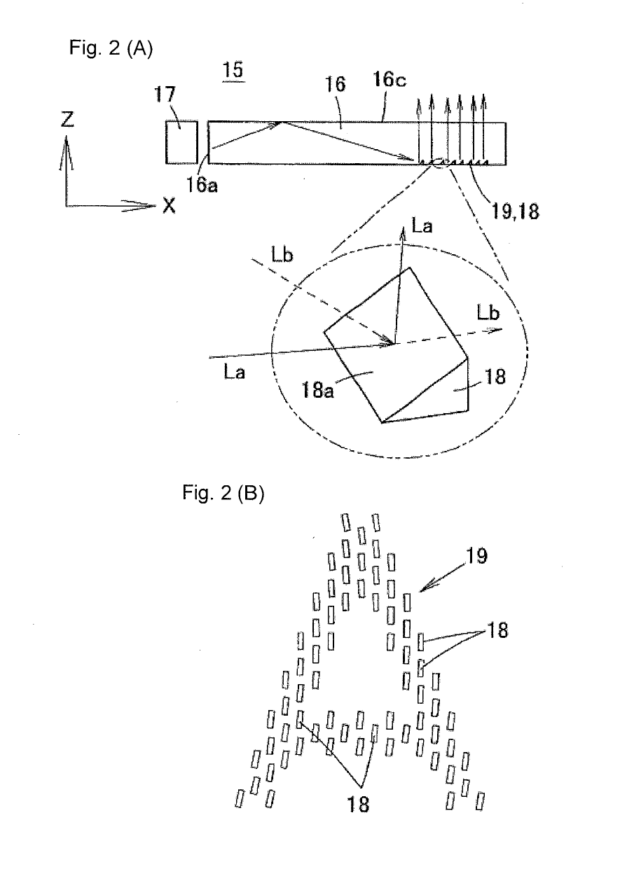

The surface illumination device according to one or more embodiments of the present invention is used in display of mobile devices such as a mobile phone, a tablet computer, and an electronic book reader. The case that the surface illumination device is used in a smartphone that is of the mobile phone will be described below. Because the smartphone is illustrated in FIG. 1(A), the smartphone is not further displayed. In the surface illumination device according to one or more embodiments of the present invention, because the conventional surface illumination device 15 is illustrated in FIGS. 1(B), 2(A), and 2(B), the component identical to that of the conventional surface illumination device 15 is designated by the identical numeral, the overlapping description is omitted, and a point different from that of the conventional surface illumination device 15 is mainly be described.

### First Embodiment

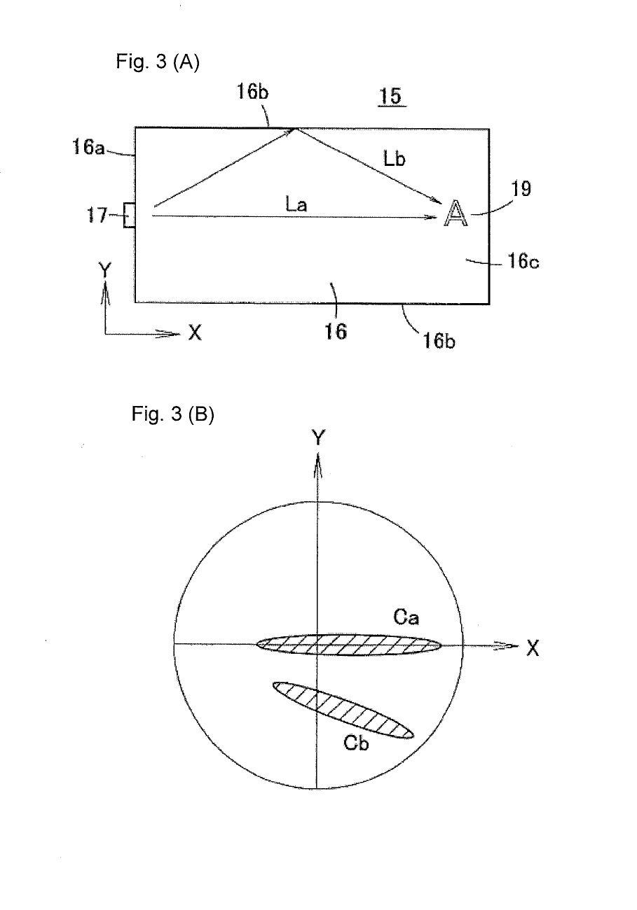

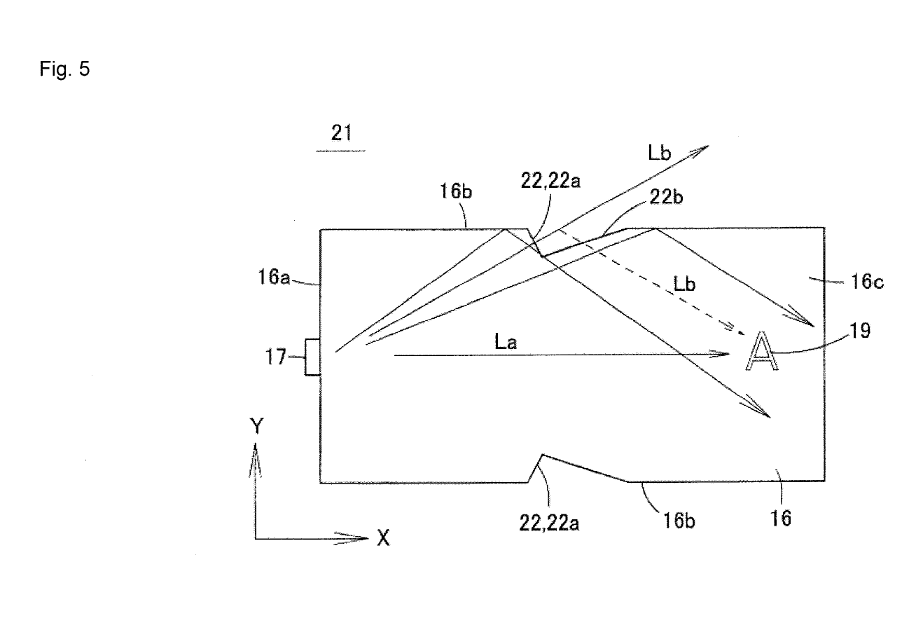

A surface illumination device 21 according to a first embodiment of the present invention will be described. FIG. 5 is a schematic plan view of the surface illumination device 21 of the first embodiment. The first embodiment focuses on light Lb, which is incident to the light guide plate 16 from the light source 17 and reaches the display unit 19 (the display region) after being totally reflected by the side surface 16b of the light guide plate 16 in the conventional surface illumination device 15 (see FIG. 3(A)).

In the surface illumination device 21 of the first embodiment, a notch 22 (the light control means) is provided in a region, where the light Lb is totally reflected by the side surface 16b, so as to transmit the incident light Lb. That is, the notch 22 includes a notch surface 22a that is irradiated with the incident light Lb and a notch surface 22b that is hardly irradiated with the light Lb. The notch surface 22a is formed at an angle such that the incident light Lb is substantially transmitted without the total reflection. For example, the angle of the notch surface 22a is fixed so as to be substantially orthogonal to a direction in which the light Lb incident from the side of the light source 17 has a maximum intensity. The angle of the notch surface 22b is fixed such that the light Lb transmitted through the notch surface 22a is not incident to the light guide plate 16 again, and such that other pieces of light are not totally reflected toward the display unit 19. For example, the notch surface 22b may be fixed so as to be substantially parallel to the direction in which the light Lb incident from the light source 17 has the maximum intensity.

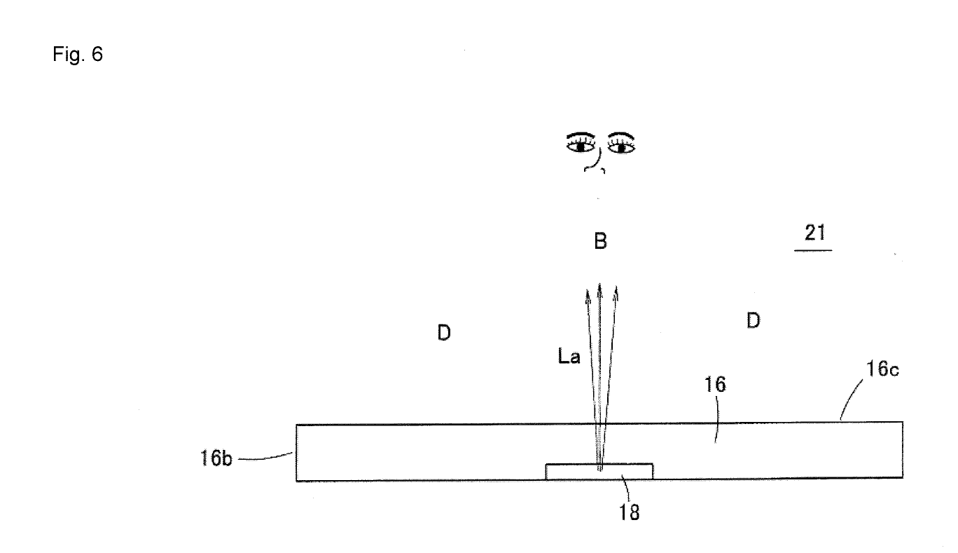

In the surface illumination device 21, the light Lb that is totally reflected by the side surface 16b of the light guide plate 16 to reach the display unit 19 in the conventional example leaks to the outside of the light guide plate 16 from the notch 22 to hardly reach the display unit 19. As illustrated in FIG. 6, the light having the high intensity only on the front side (the light having the directional pattern Cb in FIG. 3(B) is eliminated) is emitted from the light-emitting surface 16c of the light guide plate 16. As a result, the icon 13 of the smartphone 11 is not seen from the oblique direction but seen from the front. Therefore, even if the user vertically inclines the smartphone 11 or vertically moves eyes or a head, the icon 13 is not seen while flickering, but display quality of the icon 13 is improved.

The notch 22 is provided only in part of the side surface 16b of the light guide plate 16. However, as illustrated in FIG. 5, even if the light is totally reflected by a place except the notch 22, the light is reflected toward the direction deviated from the display unit 19, but the light does not shine the display unit 19. Therefore, no problem is generated.

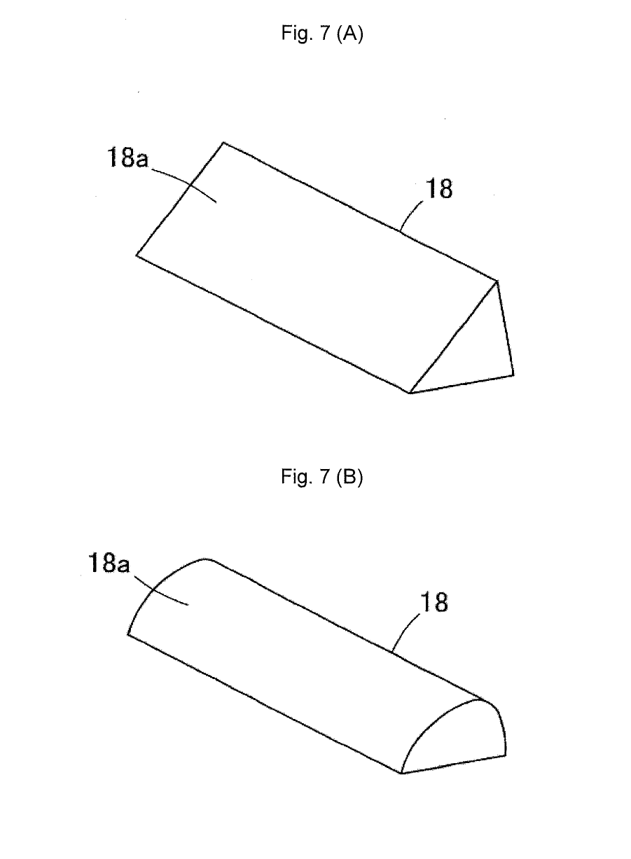

The deflection pattern 18 constituting the display unit 19 is generally formed into a triangular shape, particularly a right triangular shape as illustrated in FIG. 7(A). Alternatively, the deflection pattern 18 may be formed into a shape in which a deflection reflecting surface 18a is curved as illustrated in FIG. 7(B). The notch 22 may be provided only in one of the side surfaces 16b.

### Second Embodiment

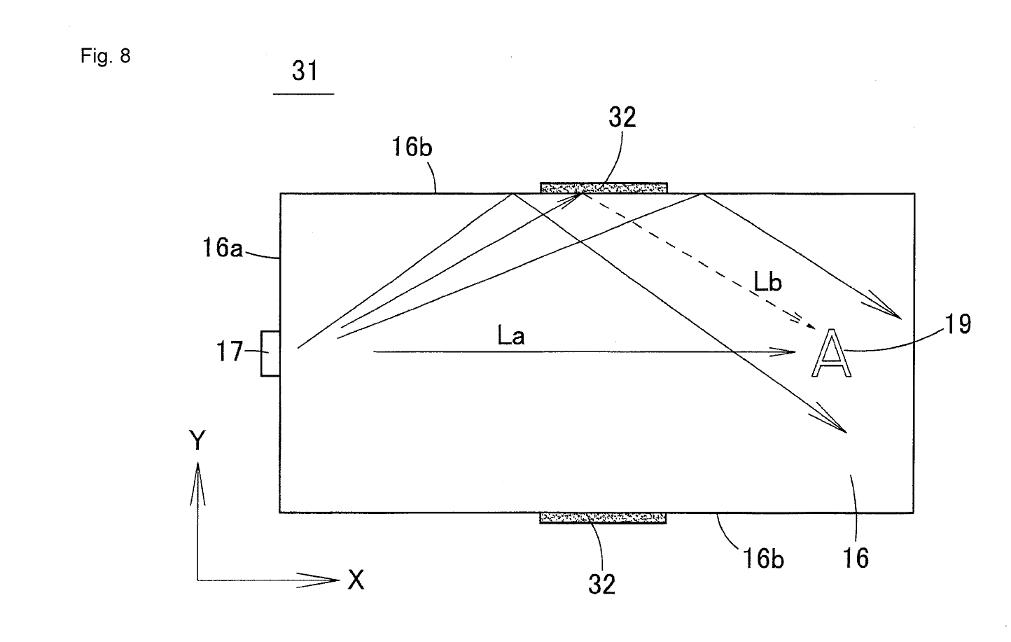

A surface illumination device 31 according to a second embodiment of the present invention will be described. FIG. 8 is a schematic plan view of the surface illumination device 31 of the second embodiment.

In the surface illumination device 31 of the second embodiment, a light-absorbing layer 32 is provided in the region, where the light Lb reaching the display unit 19 is totally reflected by the side surface 16b, by applying a black paint or attaching a black adhesive tape.

In the surface illumination device 31, the light Lb that is totally reflected by the side surface 16b of the light guide plate 16 to reach the display unit 19 in the conventional example is absorbed by the light-absorbing layer 32 and hardly totally reflected by the side surface 16b. In the second embodiment, the light having the high intensity is emitted only onto the front side from the light-emitting surface 16c. The icon 13 of the smartphone 11 is not seen from the oblique direction but seen from the front. Therefore, even if the user vertically inclines the smartphone 11 or vertically moves eyes or a head, the icon 13 is not seen while flickering, but the display quality of the icon 13 is improved.

The light-absorbing layer 32 may be provided only in one of the side surfaces 16b.

### Third Embodiment

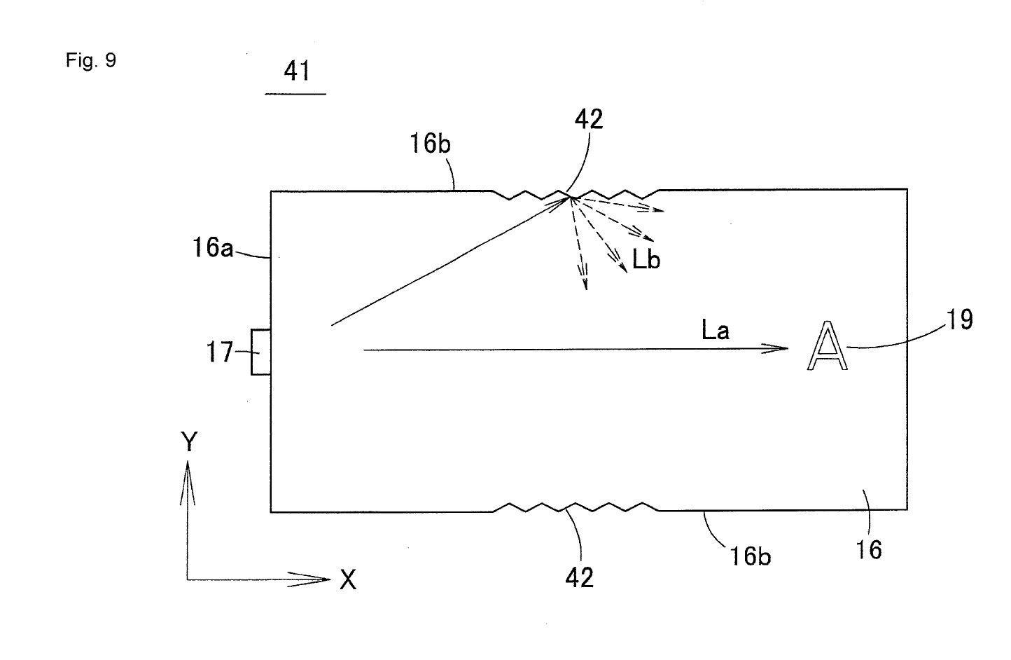

A surface illumination device 41 according to a third embodiment of the present invention will be described. FIG. 9 is a schematic plan view of the surface illumination device 41 of the third embodiment.

In the surface illumination device 41 of the third embodiment, a light scattering surface 42 is processed in the region where the light Lb reaching the display unit 19 is totally reflected by the side surface 16b. For example, the region of the side surface 16b is coarsely formed, or formed into a random prism shape.

In the surface illumination device 41, the light Lb that is totally reflected by the side surface 16b of the light guide plate 16 to reach the display unit 19 in the conventional example is scattered by the light scattering surface 42, but the light having the high intensity is not reflected in a specific direction. In the third embodiment, the light having the high intensity is emitted only onto the front side from the light-emitting surface 16c. The icon 13 of the smartphone 11 is not seen from the oblique direction but seen from the front. Therefore, even if the user vertically inclines the smartphone 11 or vertically moves eyes or a head, the icon 13 is not seen while flickering, but the display quality of the icon 13 is improved.

The light scattering surface 42 may be provided only in one of the side surfaces 16b.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A surface illumination device comprising:
a light source; and
a light guide plate having a light-emitting surface,
wherein the light guide plate light from the light source such that the light is emitted from a display region of the light-emitting surface,
wherein a plurality of deflection patterns having deflection inclined surfaces are formed in the display region in at least one of the light-emitting surface of the light guide plate and an opposite surface to the light-emitting surface, and
wherein a light control structure that reduces light is provided on at least part of at least one of the light-emitting surface of the light guide plate and a surface except the opposite surface to the light-emitting surface, the light being reflected toward the display region by the surface.

2. The surface illumination device according to claim 1, wherein the light control structure is a notch unit in which an angle is fixed such that the light incident to the light control structure is transmitted toward an outside of the light guide plate.

3. The surface illumination device according to claim 1, wherein the light control structure is a light-absorbing layer that absorbs the light incident to the light control structure.

4. The surface illumination device according to claim 1, wherein the light control structure is a light scattering surface that scatters the light incident to the light control structure.

5. A mobile phone that has transmission and reception functions, comprising:
the surface illumination device according to claim 1 that optically displays a certain shape.

6. An information terminal that has an information processing function, comprising:
the surface illumination device according to claim 1 that optically displays a certain shape.
